(19) United States
(12) Patent Application Publication
(10) Pub. No.: US 2009/0071046 A1
(43) Pub. Date: Mar. 19, 2009

(54) Decorative card enclosing liquid

(75) Inventors: Leslie Hermanson, New York, NY (US); Huang Meng-Suen, Hong Kong (CN)

Correspondence Address: FITZPATRICK CELLA HARPER & SCINTO, 30 ROCKEFELLER PLAZA, NEW YORK, NY, 10112, US

(73) Assignee: Mr. Christmas Incorporated, New York, NY (US)

(21) Appl. No.: 11/902,107

(22) Filed: Sep. 19, 2007

(51) Int. Cl. G09F 19/12

(52) U.S. Cl. 40/409; 40/124.06; 40/406; 40/408

(57) ABSTRACT

The present invention provides for a decorative card. The decorative card includes a vessel having at least a portion which is transparent, the vessel holding a liquid having particles contained therein. The decorative card also includes a back panel having an image provided on an inside surface thereof, wherein the back panel is positioned such that the image is visible through the portion of the vessel which is transparent.

### BACKGROUND OF THE INVENTION

1. Field of the Invention

The invention relates to a decorative card, and more particularly relates to a decorative card which encloses a liquid.

2. Description of the Related Art

Decorative cards come in a variety of forms, such as postcards, greeting cards and gift cards. Postcards are typically single, flat cards which are not folded, and which include a front side having an image and a back side having space for postage and address information. Greeting cards are typically illustrated and folded, and are configured to convey messages from a sender to a recipient. Gift cards are cards which typically entitle the recipient to select merchandise of an indicated cash value at a commercial establishment.

The industry for postcards, greeting cards and gift cards is a lucrative and competitive one. As such, attempts are constantly being made to produce decorative cards which stand apart from others.

### SUMMARY OF THE INVENTION

In view of the foregoing, according to one example aspect of the invention, a decorative card is provided. The decorative card includes a vessel having a portion which is at least partially transparent, the vessel containing a liquid having particles contained therein. The decorative card also includes a back panel coupled to the vessel, the back panel having an image provided on an inside surface thereof facing the portion of the vessel that is at least partially transparent, so that the image is visible through that portion.

The vessel can includes two sheets having portions which are at least partially transparent and a spacer positioned in between the two sheets.

The inside surface of the back panel can contact the liquid. The vessel can further include a border surrounding the portion of the vessel which is at least partially transparent. In a case where bubbles form in the liquid, the border reduces the visibility of the bubbles through the portion of the vessel which is at least partially transparent.

The back panel can have an outside surface facing away from the portion of the vessel that is at least partially transparent, and can include an area for providing mailing information. A gift card can be positioned behind the back panel.

The inside surface of the back panel can be attached to the vessel. The inside surface of the back panel can removably attachable to the vessel, so that the image can be replaced.

The decorative card can further include a foldable prop connected to at least one of the vessel and the back panel, so that the decorative card can be supported. The foldable prop can be connected along an edge of at least one of the vessel and the back panel. Alternatively, the foldable prop can be formed from a surface of at least one of the vessel and the back panel.

In another aspect of the invention, a decorative card according to another embodiment of the invention is provided. The decorative card includes a front panel having a portion which is at least partially transparent, and a back panel having an image provided on an inside surface thereof, facing the portion of the front panel that is at least partially transparent. The decorative card further includes a spacer positioned between the front and back panels, and adjacent a periphery of the front and back panels, wherein the front panel, back panel and spacer enclose a liquid having particles contained therein.

The front panel can further include a border surrounding the portion of the vessel which is at least partially transparent. In a case where bubbles form in the liquid, the border reduces the visibility of the bubbles through the portion of the vessel which is at least partially transparent.

The back panel in this embodiment also can have an outside surface facing away from the position of the vessel which is at least partially transparent, and can include an area for providing mailing information. A gift card can be positioned behind the back panel.

The decorative card can further include a foldable prop connected to at least one of the front panel and the back panel, so that the decorative card can be supported. The foldable prop can be connected along an edge of at least one of the front panel and the back panel. The foldable prop can be formed from a surface of at least one of the front panel and the back panel.

In yet another aspect of the invention, a decorative card according to another embodiment of the invention is provided. The decorative card includes a vessel having a portion which is at least partially transparent, the vessel containing a liquid having particles contained therein. The decorative card further includes a back panel positioned along a surface of vessel, the back panel having an image provided on an inside surface thereof facing the portion of the vessel that is at least partially transparent. In addition, the decorative card includes a front panel positioned along a surface of the vessel opposite the back panel, the front panel having a portion which is at least partially transparent. The image is visible through the portions of the front panel and vessel which are at least partially transparent.

In yet another aspect of the invention, a decorative card according to still another embodiment is provided. The decorative card in this embodiment includes a vessel having a portion which is at least partially transparent, the vessel containing a liquid having particles contained therein. The decorative card also includes a housing which secures the vessel, the housing including at least one slot for insertion of at least one of a gift card and a card having an image provided on a surface thereof. In an example case where the card having the image is positioned the at least one slot, the image faces the portion of the vessel that is at least partially transparent, so that the image is visible through that portion.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

FIG. 1 is a perspective view of a decorative card in accordance with an example embodiment of the invention.

FIG. 2 is a cross-sectional view of the decorative card of FIG. 1, as taken along line 2-2 of FIG. 1.

FIG. 3 is a perspective view of a decorative card in accordance with another example embodiment of the invention.

FIG. 4 is a cross-sectional view of the decorative card of FIG. 3, as taken along line 4-4 of FIG. 3.

FIG. 5 is a perspective view of a decorative card in accordance with a further example embodiment of the invention.

FIG. 6 is a cross-sectional view of the decorative card of FIG. 5, as taken along line 6-6 of FIG. 5.

FIG. 7 is a perspective view of a decorative card in accordance with a still further example embodiment of the invention.

FIG. 8 is a cross-sectional view of the decorative card of FIG. 7, as taken along line 8-8 of FIG. 7.

FIG. 9 is a perspective view of a decorative card in accordance with a still further example embodiment of the invention.

FIG. 10 is a cross-sectional view of the decorative card of FIG. 9, as taken along line 10-10 of FIG. 9.

FIG. 11 is a perspective view of a decorative card in accordance with a still further example embodiment of the invention.

FIG. 12 is a cross-sectional view of the decorative card of FIG. 11, as taken along line 12-12 of FIG. 11.

### DETAILED DESCRIPTION OF THE INVENTION

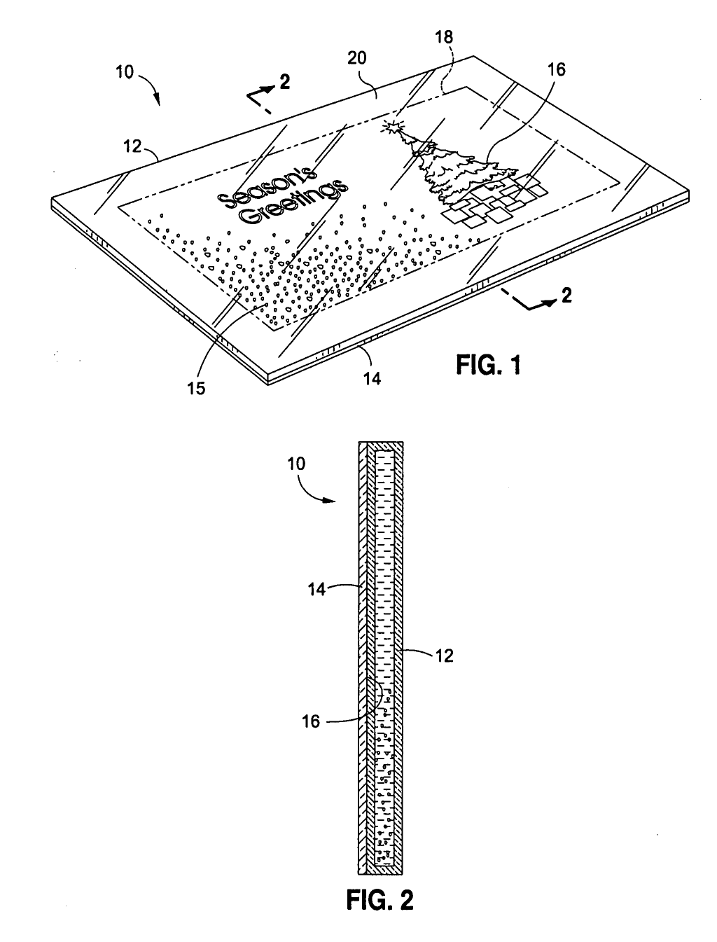

FIGS. 1 and 2 depict a decorative card 10 in accordance with an example embodiment of the invention. Although decorative card 10 is depicted as rectangular in shape, other shapes can be used. Decorative card 10 includes a vessel 12, which is a container capable of holding a liquid, and a back panel 14. Vessel 12 encloses a liquid, for example, water or another type of liquid, having particles 15 dispersed or otherwise contained therein. In this regard, vessel 12 forms a liquid-tight volume that contains the liquid.

Vessel 12 has a portion 18 which is at least partially transparent, and a border 20 which is non-transparent. Upon agitation of decorative card 10, such that the particles 15 temporarily become afloat within the volume of the liquid, the particles 15 slowly settle to the bottom of vessel 12 and create a snow fall effect which is visible through transparent portion 18.

Although any transparent material (e.g., glass) can be used for transparent portion 18, a pliable plastic transparent material that is not brittle is preferred. Such pliable plastic is preferred because such plastic is less likely to crack if bent or distorted in shape and because [INVENTORS: PLEASE PROVIDE OTHER REASONS (IF ANY) FOR WHY PLIABLE PLASTIC IS PREFERRED].

Border 20 provides a frame-like appearance for decorative card 10. In addition, in the event that bubbles form within the liquid, the bubbles typically form only along the periphery of vessel 12. Border 20 is preferably configured to cover or otherwise substantially shield the bubbles from view, so that they are less visible or not visible through transparent portion 18. In this regard, border 20 may partially overlap at least one outside edge, and preferably the peripheral edge, of transparent portion 18. It should be noted that although vessel 12 is depicted to have border 20, vessel 12 may instead be completely transparent and have no border.

Back panel 14 has an image 16, such as a decorative image, picture, character(s) or the like, provided on an inside surface thereof and facing towards transparent portion 18. In addition, back panel 14 is positioned such that image 16 is visible through transparent portion 18 of vessel 12. In this regard, the inside surface of back panel 14 is preferably attached to a back wall of vessel 12, through any suitable securing mechanism. Alternatively, back panel 14 can be removably attachable to a back wall of vessel 12, so that image 16 can be replaced with images of different back panels.

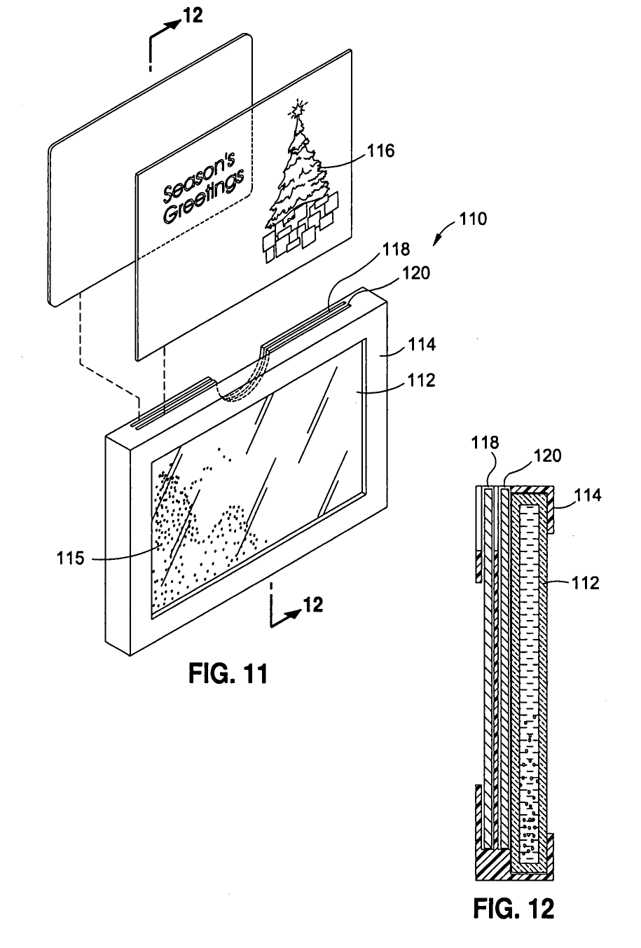

In this regard, image 16 can be formed directly on the inside surface of back panel 14. Alternatively, image 16 can be a part of a separate portion which can be removably inserted along the inside surface of back panel 14. For example, back panel 14 may include a slot (not shown) similar to slot 120 of FIGS. 11 and 12 (described below), for insertion of the separate portion.

Decorative card 10 may be, for example, a postcard. In such a case, an outside surface of back panel 14 facing away from portion 18 preferably includes an area on which mailing information such as, for example, a stamp, mailing address, and the like can be provided. Alternatively, decorative card 10 may be used for presentation of a gift card. In such a case, a gift card is preferably positioned behind the back panel 14, and is preferably removably attached to decorative card 10. For example, back panel 14 may include a slot (not shown) similar to slot 118 of FIGS. 11 and 12, for insertion of a gift card.

In summary, decorative card 10 of FIGS. 1 and 2 includes a vessel 12 having a portion 18 which is at least partially transparent, the vessel 12 containing a liquid having particles 15 contained therein. Decorative card 10 also includes a back panel 14 coupled to the vessel 12, the back panel 14 having an image 16 provided on an inside surface thereof facing the portion 18 of the vessel 12 that is at least partially transparent, so that the image 16 is visible through portion 18.

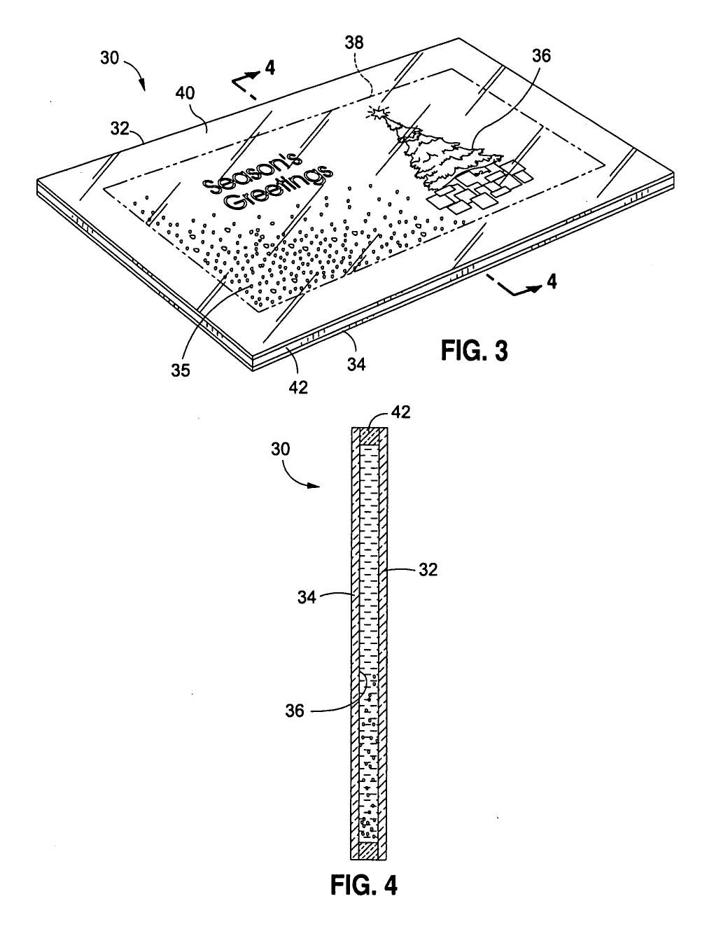

FIGS. 3 and 4 depict a decorative card in accordance with another example embodiment of the invention. Although decorative card 30 is depicted as rectangular in shape, other shapes can be provided. Decorative card 30 includes a front panel 32, a back panel 34 and a spacer 42. Front panel 32, back panel 34 and spacer 42 enclose a liquid, for example, water or another type of liquid, having particles 35 dispersed or otherwise contained therein. In this regard, front panel 32, back panel 34 and spacer 42 form a liquid-tight volume that contains the liquid.

Front panel 32 has a portion 38 which is at least partially transparent, and a border 40 which is non-transparent. Upon agitation of decorative card 30, such that the particles 35 temporarily become afloat within the volume of the liquid, the particles 35 slowly settle to the bottom of decorative card 30 and create a snow fall effect which is visible through transparent portion 38. A pliable plastic material is preferred at least for transparent portion 38, for reasons noted above.

Border 40 provides a frame-like appearance for decorative card 30. In addition, in the event that bubbles form within the liquid, the bubbles typically form only along the periphery of decorative card 30. Border 40 is preferably configured to cover or otherwise substantially shield the bubbles from view, so that they are less visible or not visible through transparent portion 38. In this regard, border 40 may partially overlap at least one outside edge, and preferably the peripheral edge, of transparent portion 38. It should be noted that although front panel 32 is depicted to have border 40, front panel 32 may instead be completely transparent and have no border.

Back panel 34 has an image 36, such as a decorative image, picture, character(s) or the like, provided on an inside surface thereof and facing towards transparent portion 38. Spacer 42 is positioned peripherally about image 36 and in between front panel 32 and back panel 34. In addition, back panel 34 is positioned such that image 36 is visible through transparent portion 38 of front panel 32. In this regard, spacer 42 is preferably attached to the inside surface of back panel 34 and to front panel 32, through any suitable securing mechanism. As noted above, front panel 32, back panel 34 and spacer 42 enclose a liquid having particles 35 contained therein, such that upon agitation, a snow fall effect is created which is visible through transparent portion 38.

In this regard, image 36 can be formed directly on the inside surface of back panel 34. Alternatively, image 36 can be part of a separate portion which can be removably inserted along the inside surface of back panel 34. For example, back panel 34 may include a slot (not shown) similar to slot 120 of FIGS. 11 and 12 (described below), for insertion of the separate portion.

Decorative card 30 may be, for example, a postcard. In such a case, an outside surface of back panel 34 facing away from portion 38 preferably includes an area on which mailing information such as, for example, a stamp, mailing address, and the like can be provided. Alternatively, decorative card 30 may be used for presentation of a gift card. In such a case, a gift card is preferably positioned behind the back panel 34, and is preferably removably attached to decorative card 30. For example, back panel 34 may include a slot (not shown) similar to slot 118 of FIGS. 11 and 12, for insertion of a gift card.

In summary, decorative card 30 of FIGS. 3 and 4 includes a front panel 32 having a portion 38 which is at least partially transparent, and a back panel 34 having an image 36 provided on an inside surface thereof, facing the portion 38 of the front panel 32 that is at least partially transparent. Decorative card 30 further includes a spacer 42 positioned between the front panel 32 and back panel 34, and adjacent a periphery of the front 32 and back panel 34. The front panel 32, back panel 34 and spacer 42 enclose a liquid having particles 35 contained therein.

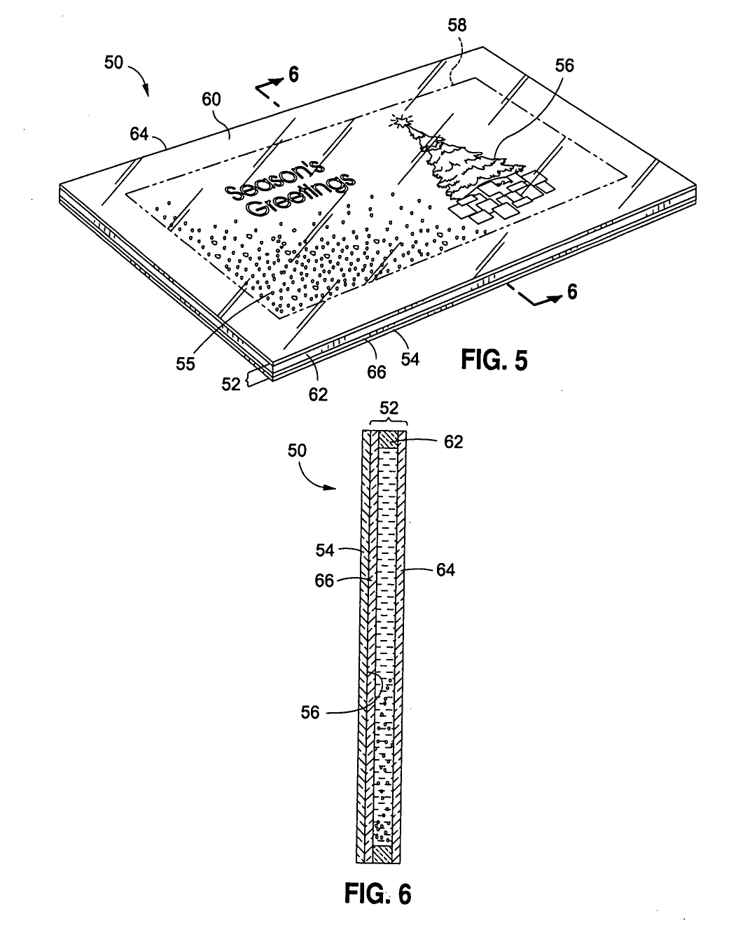

FIGS. 5 and 6 depict a decorative card in accordance with another embodiment of the invention. Although decorative card 50 is depicted as rectangular in shape, other shapes can be provided. Decorative card 50 includes a front panel 52, which includes a first sheet 64, a spacer 62 and a second sheet 66. First sheet 64, spacer 62 and second sheet 66 enclose a liquid, for example, water or another type of liquid, having particles 55 dispersed or otherwise contained therein. In this regard, first sheet 64, spacer 62 and second sheet 66 form a liquid-tight volume that contains the liquid.

First sheet 64 and second sheet 66 each have portions 58 which are at least partially transparent, and borders 60 which are non-transparent. Upon agitation of decorative card 50, such that the particles 55 temporarily become afloat within the volume of the liquid, the particles 55 slowly settle to the bottom of decorative card 50 and create a snow fall effect which is visible through transparent portions 58. A pliable plastic material is preferred for at least transparent portions 58, for reasons noted above.

Borders 60 provide a frame-like appearance for decorative card 50. In addition, in the event that bubbles form within the liquid, the bubbles typically form only along the periphery of decorative card 50. Borders 60 are preferably configured to cover or otherwise substantially shield the bubbles from view, so that they are less visible or not visible through transparent portions 58. In this regard, border 60 may partially overlap at least one outside edge, and preferably the peripheral edge, of transparent portion 58. It should be noted that although first sheet 64 and second sheet 66 are depicted to have borders 60, first sheet 64 and second sheet 66 may instead be completely transparent and have no border.

Decorative card 50 includes a back panel 54. Back panel 54 has an image 56, such as a decorative image, picture, characters, or the like, provided on an inside surface thereof and facing towards transparent portions 58. In addition, back panel 54 is positioned such that image 56 is visible through transparent portions 58. The inside surface of back panel 54 is preferably attached to front panel 52, through any suitable securing mechanism. As noted above, first sheet 64, spacer 62 and second sheet 66 enclose a liquid having particles 55 contained therein, such that upon agitation, a snow fall effect is created which is visible through transparent portions 58.

In this regard, image 56 can be formed directly on the inside surface of back panel 54. Alternatively, image 56 can be part of a separate portion which can be removably inserted along the inside surface of back panel 54. For example, back panel 54 may include a slot (not shown) similar to slot 120 of FIGS. 11 and 12 (described below), for insertion of the separate portion.

Decorative card 50 may be, for example, a postcard. In such a case, an outside surface of back panel 54 facing away from portions 58 preferably includes an area on which mailing information such as, for example, a stamp, mailing address, and the like can be provided. Alternatively, decorative card 50 may be used for presentation of a gift card. In such a case, a gift card is preferably positioned behind the back panel, and is preferably removably attached to decorative card 50. For example, back panel may include a slot (not shown) similar to slot 118 of FIGS. 11 and 12, for insertion of a gift card.

In summary, decorative card 50 of FIGS. 5 and 6 includes a vessel having two sheets 64 and 66 having portions 58 which are at least partially transparent and a spacer 62 positioned in between the two sheets 64 and 66. The two sheets 64 and 66 and spacer 62 contain a liquid having particles contained therein. The decorative card 50 also includes a back panel 54 coupled to the second sheet 66, the back panel 54 having an image 56 provided on an inside surface thereof facing the portions 58 that are at least partially transparent, so that the image 56 is visible through those portions 58.

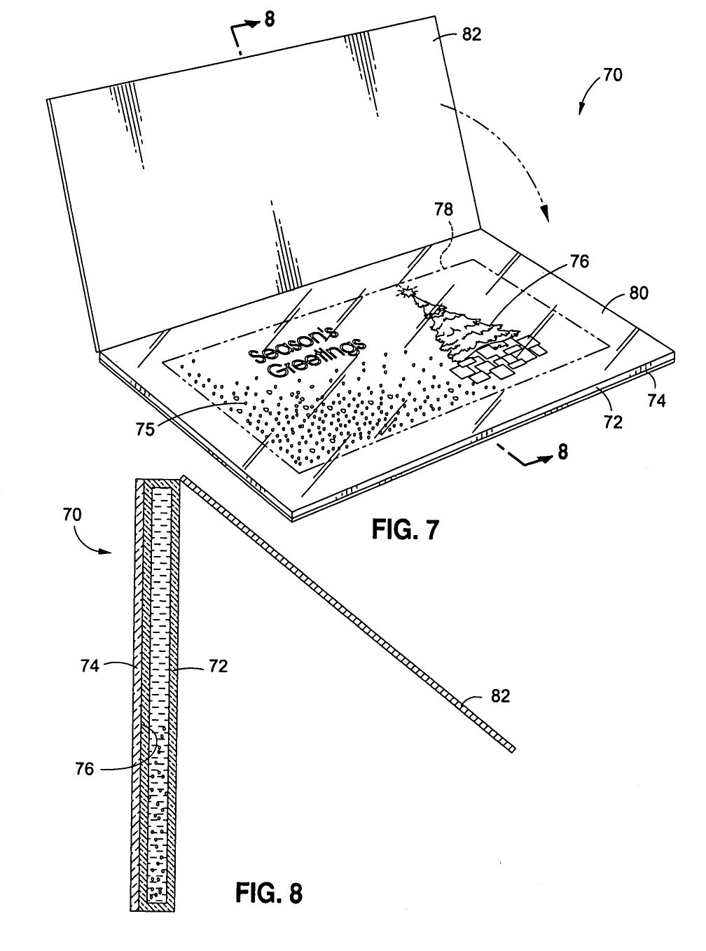

FIGS. 7 and 8 depict a decorative card in accordance with a further example embodiment of the invention. Although decorative card 70 is depicted as rectangular in shape, other shapes can be provided. Decorative card 70 is similar to decorative card 10 of FIGS. 1 and 2, and includes a vessel 72, back panel 74, particles 75, image 76, transparent portion 78 and border 80. However, decorative card 70 further includes a foldable prop 82 which is connected to at least one of vessel 72 and back panel 74, and which, in one example embodiment, is configured to support decorative card 70 to stand up. Also, in one example embodiment, foldable prop 82 can be opened to expose image 76, or closed to cover image 76. Foldable prop 82 can be connected along an edge of at least one of vessel 72 and back panel 74. In an alternate configuration (not shown), foldable prop 82 can be formed on the outside surface of back panel 74, or on a surface of vessel 72. Furthermore, it should be noted that a foldable prop can also be included for the decorative cards corresponding to the example embodiments of FIGS. 3 to 6, and the foldable prop 82 can be connected to vessel 72 and/or panel 74 through any suitable securing mechanism, such as through a hinge configuration, an adhesive, or the like.

In summary, decorative card 70 of FIGS. 7 and 8 includes a foldable prop connected to at least one of the vessel 72 and the back panel 74, so that the decorative card 70 can be supported and/or provided with a cover.

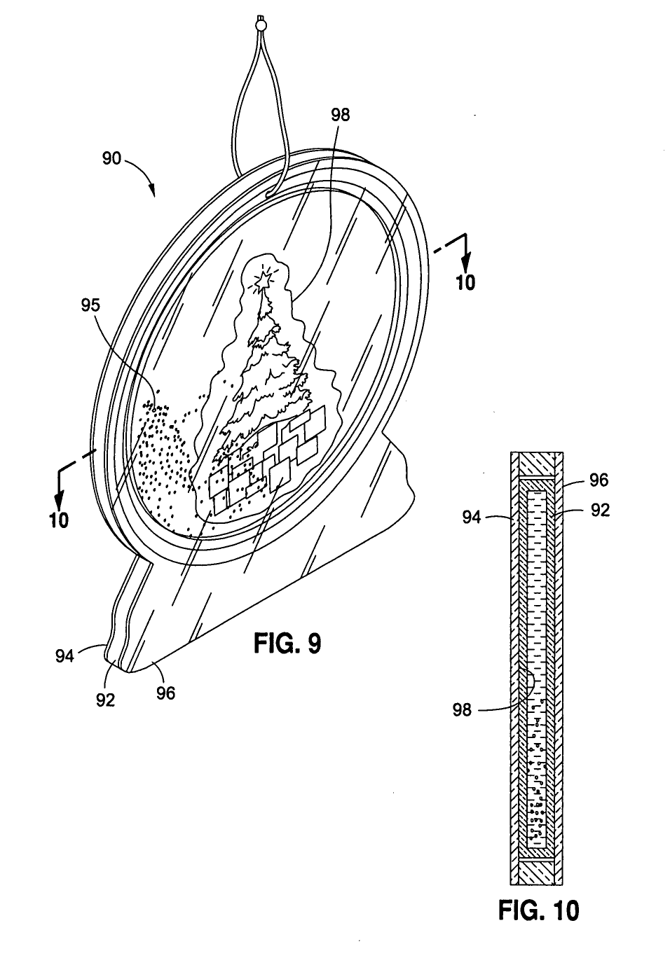

FIGS. 9 and 10 depict a decorative card in accordance with a further example embodiment of the invention. Although decorative card 90 is depicted as at least partially circular in shape, other ornamental or non-ornamental shapes can be provided. Decorative card 90 includes a vessel 92, which is a container capable of holding a liquid. Vessel 92 encloses a liquid, for example, water or another type of liquid, having particles 95 dispersed or otherwise contained therein. In this regard, vessel 92 forms a liquid-tight volume that contains the liquid. In addition, vessel 92 contains a portion which is at least partially transparent.

Vessel 92 is positioned between a front panel 96 and back panel 94. Each of front panel 96 and back panel 94 contain portions which are at least partially transparent. Upon agitation of decorative card 90, such that the particles 95 temporarily become afloat within the volume of the liquid, the particles 95 slowly settle to the bottom of vessel 92 and create a snow fall effect which is visible through at least the transparent portion of front panel 96 and/or back panel 94. A pliable plastic material is preferred for at least the transparent portions of vessel 92, front panel 96 and back panel 94, for reasons noted above.

Back panel 94 has an image 98, such as a decorative image, picture, character(s) or the like, provided on an inside surface thereof and facing towards front panel 96. In addition, back panel 94 is positioned such that image 98 is visible from front panel 96. In this regard, the inside surface of back panel 96 is preferably attached to a back wall of vessel 92, through any suitable securing mechanism. Alternatively, back panel 96 can be removably attachable to a back wall of vessel 92, so that image 98 can be replaced with images of different back panels.

In this regard, image 98 can be formed directly on the inside surface of back panel 96. Alternatively, image 98 can be part of a separate portion which can be removably inserted along the inside surface of back panel 96. For example, back panel 94 may include a slot (not shown) similar to slot 120 of FIGS. 11 and 12 (described below), for insertion of the separate portion.

Decorative card 90 may be, for example, a postcard. In such a case, an outside surface of back panel 96 preferably includes an area on which mailing information such as, for example, a stamp, mailing address, and the like can be provided. Alternatively, decorative card 90 may be used for presentation of a gift card. In such a case, a gift card is preferably positioned behind the back panel, and is preferably removably attached to decorative card 90. For example, back panel 36 may include a slot (not shown) similar to slot 118 of FIGS. 11 and 12, for insertion of a gift card.

In summary, decorative card 90 of FIGS. 9 and 10 includes a vessel 92 having a portion which is at least partially transparent, the vessel 92 containing a liquid having particles 95 contained therein. The decorative card 92 further includes a back panel 94 positioned along a surface of vessel 92, the back panel 94 having an image 98 provided on an inside surface thereof facing the portion of the vessel 92 that is at least partially transparent. In addition, the decorative card 90 includes a front panel 96 positioned along a surface of the vessel 92 opposite the back panel 94, the front panel 96 having a portion which is at least partially transparent. The image 98 is visible through the portions of the front panel 96 and vessel 92 which are at least partially transparent.

FIGS. 11 and 12 depict a decorative card in accordance with a further example embodiment of the invention. Although decorative card 110 is depicted as rectangular in shape, other shapes can be provided. Decorative card 110 is preferably used for presentation of a gift card.

Decorative card 110 includes a vessel 112, which is a container capable of holding a liquid. Vessel 112 encloses a liquid, for example, water or another type of liquid, having particles 115 dispersed or otherwise contained therein. In this regard, vessel 112 forms a liquid-tight volume that contains the liquid. In addition, vessel 112 is at least partially transparent.

Vessel 112 is positioned within a housing 114, which secures vessel 112 and which is formed so that the transparent portion of vessel 112 is visible. Upon agitation of decorative card 110, such that the particles 115 temporarily become afloat within the volume of the liquid, the particles 115 slowly settle to the bottom of vessel 112 and create a snow fall effect which is visible through at least the transparent portion of vessel 112. A pliable plastic material is preferred for the transparent portions of vessel 112, for reasons noted above.

Housing 114 includes two slots 118 and 120. Slot 118 can be used for insertion and presentation of gift card, and slot 120 can be used for insertion and presentation of a card including an image 116, for example. Although slots 118 and 120 may be positioned different than depicted, so that cards, for example, can be inserted from the side of bottom, instead of from the top. In addition, although two slots 118 and 120 are depicted, only one slot, or more than two slots, may be provided.

Image 116 can be a decorative image, picture, characters, or the like, and preferably faces towards vessel 112. In addition, image 116 is positioned to be visible through vessel 112. Since image 116 is included on a separate card, image 116 can be replaced with images on different cards.

In summary, decorative card 110 of FIGS. 11 and 12 includes a vessel 112 having a portion which is at least partially transparent, the vessel 112 containing a liquid having particles 115 contained therein. The decorative card 110 also includes a housing 114 which secures the vessel 112, the housing 114 including at least one slot (118 and/or 120) for insertion of at least one of a gift card and a card having an image 116 provided on a surface thereof. In a case where the card having the image is positioned the at least one slot, the image 116 can face the portion of the vessel that is at least partially transparent, so that the image 116 is visible through that portion.

It should be noted that the various components for forming the above decorative cards can be separate components or can be integrally formed.

The invention has been described above with respect to particular illustrative embodiments. It is understood that the invention is not limited to the above-described embodiments and that various changes and modifications may be made by those skilled in the relevant art without departing from the spirit and scope of the invention.

What is claimed is:

1. A decorative card, comprising:
a vessel having a portion which is at least partially transparent, the vessel containing a liquid having particles contained therein; and
a back panel coupled to the vessel, the back panel having an image provided on an inside surface thereof facing the portion of the vessel that is at least partially transparent, so that the image is visible through that portion.

2. A decorative card according to claim 1, wherein the vessel comprises two sheets having portions which are at least partially transparent and a spacer positioned in between the two sheets.

3. A decorative card according to claim 1, wherein the inside surface of the back panel contacts the liquid.

4. A decorative card according to claim 1, wherein the vessel further includes a border surrounding the portion of the vessel which is at least partially transparent, wherein in a case where bubbles form in the liquid, the border reduces the visibility of the bubbles.

5. A decorative card according to claim 1, wherein the back panel has an outside surface facing away from the portion of the vessel that is at least partially transparent, and which includes an area for providing mailing information.

6. A decorative card according to claim 1, wherein a gift card is positioned behind the back panel.

7. A decorative card according to claim 1, wherein the inside surface of the back panel is attached to the vessel.

8. A decorative card according to claim 1, wherein the inside surface of the back panel is removably attachable to the vessel, so that the image can be replaced.

9. A decorative card according to claim 1, further comprising a foldable prop connected to at least one of the vessel and the back panel, so that the decorative card can be supported.

10. A decorative card according to claim 9, wherein the foldable prop is connected along an edge of at least one of the vessel and the back panel.

11. A decorative card according to claim 9, wherein the foldable prop is formed from a surface of at least one of the vessel and the back panel.

12. A decorative card, comprising:
a front panel having a portion which is at least partially transparent;
a back panel having an image provided on an inside surface thereof, facing the portion of the front panel that is at least partially transparent;
a spacer positioned between the front and back panels, and adjacent a periphery of the front and back panels,
wherein the front panel, back panel and spacer enclose a liquid having particles contained therein.

13. A decorative card according to claim 12, wherein the front panel further includes a border surrounding the portion of the vessel which is at least partially transparent, wherein in a case where bubbles form in the liquid, the border reduces the visibility of the bubbles.

14. A decorative card according to claim 12, wherein the back panel has an outside surface facing away from the position of the vessel which is at least partially transparent, and which includes an area for providing mailing information.

15. A decorative card according to claim 12, wherein a gift card is positioned behind the back panel.

16. A decorative card according to claim 12, further comprising a foldable prop connected to at least one of the front panel and the back panel.

17. A decorative card according to claim 16, wherein the foldable prop is connected along an edge of at least one of the front panel and the back panel.

18. A decorative card according to claim 16, wherein the foldable prop is formed from a surface of at least one of the front panel and the back panel.

19. A decorative card, comprising:
a vessel having a portion which is at least partially transparent, the vessel containing a liquid having particles contained therein;
a back panel positioned along a surface of vessel, the back panel having an image provided on an inside surface thereof facing the portion of the vessel that is at least partially transparent; and
a front panel positioned along a surface of the vessel opposite the back panel, the front panel having a portion which is at least partially transparent,
wherein the image is visible through the portions of the front panel and vessel which are at least partially transparent.

20. A decorative card, comprising:
a vessel having a portion which is at least partially transparent, the vessel containing a liquid having particles contained therein; and
a housing which secures the vessel, the housing including at least one slot for insertion of at least one of a gift card and a card having an image provided on a surface thereof,
wherein in a case where the card having the image is positioned in the at least one slot, the image faces the portion of the vessel that is at least partially transparent, so that the image is visible through that portion.
